(19) United States
(12) Patent Application Publication
(10) Pub. No.: US 2018/0346680 A1
(43) Pub. Date: Dec. 6, 2018

(54) FOAM COMPOSITES

(71) Applicant: XFLAM PTY LTD, South Melbourne (AU)

(72) Inventors: WREN BRACEGIRDLE, South Melbourne (AU); STEPHEN CLARKE, South Melbourne (AU); STEPHEN MCMILLAN, South Melbourne (AU); MURRAY ORPIN, Leominster (GB)

(73) Assignee: XFLAM PTY LTD, South Melbourne (AU)

(21) Appl. No.: 16/058,824

(22) Filed: Aug. 8, 2018

Related U.S. Application Data
(63) Continuation of application No. PCT/AU2017/050075, filed on Feb. 7, 2017.

(30) Foreign Application Priority Data
Feb. 12, 2016 (AU) 2016900483

(51) Int. Cl. C08J 9/35; C08L 61/06; C08J 9/18

(52) U.S. Cl. CPC C08J 9/35; C08L 61/06; C08J 9/18; C08L 2203/14; B29C 44/02; C08J 2203/22; C08J 2361/06; C08J 2425/06; C08L 2205/20

(57) ABSTRACT

Polystyrene-phenolic foam composites and processes for their preparation are provided. The composites have very low density yet retain advantageous mechanical properties. The composites have excellent fire resistance properties and find application in the production of insulation panels.

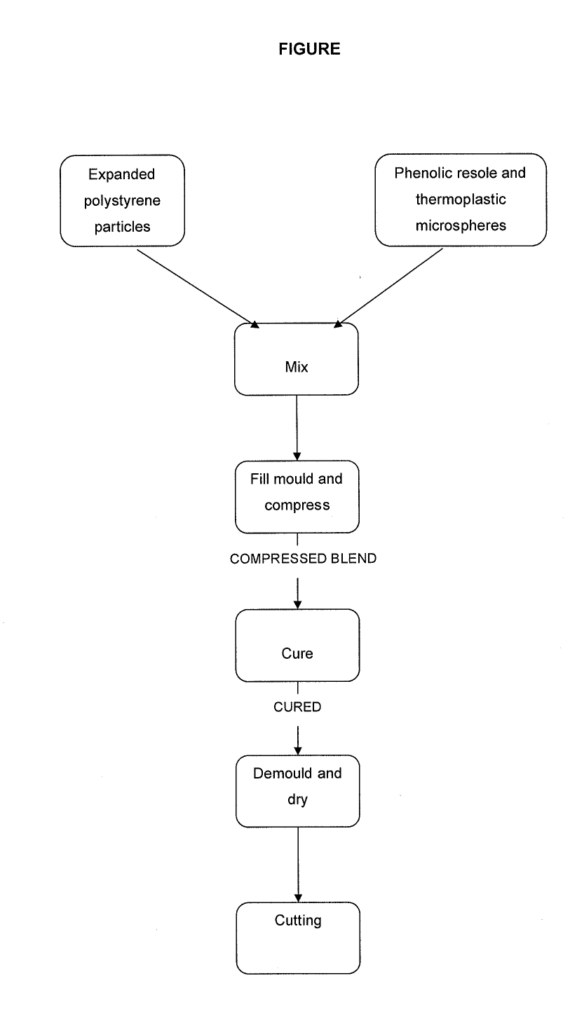

### CROSS-REFERENCE TO RELATED APPLICATIONS

The present application is a continuation application of PCT/AU2017/050075, filed Feb. 7, 2017, which application claims priority to Application No. AU 2016900483, filed Feb. 12, 2016, the contents of which are incorporated herein by reference for all purposes.

### FIELD

The present disclosure relates to polystyrene-phenolic foam composites and processes for their preparation. The processes yield composites having advantageous properties particularly, although not exclusively, useful in insulation and fire resisting applications.

### BACKGROUND

Polystyrene foam slabs or forms are widely used for thermal and acoustic insulation in building construction. However, a disadvantage of polystyrene foams is their high propensity to burn and/or melt in a fire leading to the loss of structural strength.

In contrast, foams with a phenolic resin matrix, that is phenolic foams, as a class of materials, are known for their excellent fire resistance and thermal properties, but their commercial potential in many fields of application is impeded due to their poor structural properties characterised by high brittleness and friability.

Composites of polystyrene and phenolic resins are known, for example WO 2004/046232 A1 discloses a syntactic phenolic foam composition comprising a phenolic resole resin and thermoplastic microspheres. An example of a polystyrene composite comprising the syntactic phenolic foam composition is disclosed, although the density of the polystyrene composite is very high, at 40 kg/m³ and above.

WO 2014/179841 A1 discloses a process for preparing a polystyrene-phenolic foam composite comprising combining expandable polystyrene, phenolic resole resin and expandable thermoplastic microspheres and curing the resulting mixture with steam.

It would be desirable to develop processes to manufacture lower density polystyrene based foam products. This would advantageously reduce shipping costs of the resulting slabs or forms. It would also be desirable to identify foam products which have improved fire resisting properties. The present disclosure addresses these needs.

The reference in this specification to any prior publication (or information derived from it), or to any matter which is known, is not, and should not be taken as an acknowledgement or admission or any form of suggestion that that prior publication (or information derived from it) or known matter forms part of the common general knowledge in the field of endeavour to which this specification relates.

### SUMMARY

There is provided a process for preparing a polystyrene-phenolic foam composite comprising the steps of:
a) forming a mixture of thermoplastic microspheres, phenolic resole resin, polystyrene particles and at least one acidic catalyst; and
b) curing the mixture formed in a) at a temperature greater than 40° C.;
   wherein the polystyrene particles have a density of less than 15 kg/m³ and;
   wherein the polystyrene-phenolic foam composite has a density of less than 40 kg/m³.

There is also provided a process for preparing a polystyrene-phenolic foam composite comprising the steps of:
a) forming a mixture of thermoplastic microspheres, phenolic resole resin and at least one acidic catalyst;
b) combining the mixture formed in a) with polystyrene particles to form a mixture; and
c) curing the mixture formed in b) at a temperature greater than 40° C.;
   wherein the polystyrene particles have a density of less than 15 kg/m³ and;
   wherein the polystyrene-phenolic foam composite has a density of less than 40 kg/m³.

There is also provided a process for preparing a polystyrene-phenolic foam composite comprising the steps of:
a) forming a mixture of thermoplastic microspheres and phenolic resole resin;
b) combining the mixture formed in a) with at least one acidic catalyst;
c) combining the mixture formed in b) with polystyrene particles; and
d) curing the mixture formed in c) at a temperature greater than 40° C.;
   wherein the polystyrene particles have a density of less than 15 kg/m³ and;
   wherein the polystyrene-phenolic foam composite has a density of less than 40 kg/m³.

There is also provided a polystyrene-phenolic foam composite comprising:
a) expanded polystyrene having a density of less than 15 kg/m³;
b) cured phenolic resole resin; and
c) expanded thermoplastic microspheres;
   wherein the composite has a density of less than 40 kg/m³.

The expanded polystyrene may be present in the composite in an amount up to 60% by weight, based on the total weight of the composite.

The phenolic resole resin may be present in the composite in an amount of 50% by weight or more, or 40% by weight or more, based on the total weight of the composite.

The composites disclosed herein offer all the benefits of expanded polystyrene insulation materials along with improved strength and thermal insulation performance.

It is surprising and counter-intuitive that such low density composites retain high mechanical strength.

The composites address the inherent fire risk of expanded polystyrene as they are self-extinguishing, do not melt or drip and are capable of providing a fire barrier rating of up to 120 minutes.

The composites have excellent water resistance wherein the phenolic resin element is effectively pH neutral.

In any of the herein disclosed embodiments the curing may occur at a temperature between 50° C. and 120° C., or between 50° C. and 110° C., or between 50° C. and 100° C. Curing may be facilitated by the application of heat to the mixture and/or through the release of exothermic heat associated with the cure.

In any of the herein disclosed embodiments the mixture to be cured may be first subjected to compression. The compression may be performed at a temperature above 20° C., or above 40° C., or between 40° C. and 60° C.

In any of the herein disclosed embodiments the mixture prior to compression may have a volume which is between 100 and 200% of the volume after compression. The volume of the mixture prior to compression may be between 100 and 180% of the volume after compression. The volume of the mixture prior to compression may be greater than 110% of the volume after compression, or greater than 120%, or greater than 130%, or greater than 140%, or greater than 150%, or between 140 and 180%, or between 140 and 170%.

In any of the herein disclosed embodiments the compressed mixture may be cured under the curing conditions disclosed herein.

In any of the herein disclosed embodiments the curing may occur in the absence of added steam. In any of the herein disclosed embodiments the curing may occur in the absence of added water.

There is also provided a process for preparing a polystyrene-phenolic foam composite comprising the steps of:
a) forming a mixture of thermoplastic microspheres, phenolic resole resin, polystyrene particles and at least one acidic catalyst; and
b) curing, in the absence of added steam, the mixture formed in a) at a temperature greater than 40° C.;
   wherein the polystyrene particles have a density of less than 15 kg/m³ and;
   wherein the polystyrene-phenolic foam composite has a density of less than 40 kg/m³.

### Polystyrene Particles

In the herein disclosed composites, polystyrene provides the bulk of the material volume imparting a low density. A microcellular matrix of phenolic resin creates a fire resistant framework throughout the material.

The polystyrene particles may be expanded or partially expanded. The polystyrene particles may have an average particle size between 0.1 and 10 mm, or an average particle size between 1 and 9 mm, or an average particle size between 2 and 8 mm or an average particle size of between 3 and 7 mm.

When partially expanded polystyrene particles are used they contain at least one blowing agent. The polystyrene blowing agent and technique may comprise the employment of liquid physical blowing agents, the agents which are volatile liquids which produce a blowing gas through vaporisation of the blowing agent or through decomposition of the blowing agent when heated.

Numerous blowing agents suitable for use are well known in the art. The blowing agent may be a liquid having an atmospheric pressure boiling point between −50° and 100° C., or between 0° and 50° C.

Examples of blowing agents include organic compounds such as hydrocarbons, halogenated hydrocarbons, alcohols, ketones and ethers. Specific examples of hydrocarbon blowing agents include propane, butane, pentane, isopentane and hexane. Pentane is an exemplary blowing agent.

The amount of blowing agent present in the expanded polystyrene particles may be between 1 and 12% by weight, or between 2 and 10% or between 4 and 8%.

The polystyrene particles may be derived from styrene polymers that are commonly used for preparing polystyrene particles that are to be blown to form polystyrene foam particles. As well as using styrene as the sole monomer other addition polymerisable monomers may be used and such copolymers are embraced by the term polystyrene in this specification. Styrene is always present as the major component of the polystyrene polymer.

The polystyrene particles may be partially expanded polystyrene particles or fully expanded polystyrene particles or mixtures thereof. Preferably, fully expanded polystyrene particles are utilised. The polystyrene particles may have a density less than 15 kg/m³, or less than 14 kg/m³, or less than 13 kg/m³, or less than 12 kg/m³, or less than 11 kg/m³, or less than 10 kg/m³, or less than 9 kg/m³, or less than 8 kg/m³, or less than 7 kg/m³, or less than 6 kg/m³, or less than 5 kg/m³. The polystyrene particles may have a density in the range from about 5 kg/m³ to about 15 kg/m³ or from about 5 kg/m³ to about 10 kg/m³.

The polystyrene particles may be modified by the addition of one or more additives, such as flame retardants, smoke suppressants, antistatic agents, flowability improvers, foaming modifiers, and other additives commonly found or used in polystyrene particles. For example, the polystyrene particles may be coated or impregnated with carbon or graphite.

### Phenolic Resole Resin

Base-catalysed phenol-formaldehyde resins made with a formaldehyde to phenol ratio of greater than one (usually around 1.5) may be termed resoles. A suitable phenolic resole resin as used herein may have a viscosity of between 500-4,000 cP at a temperature of 25° C., or a viscosity of between 1000-3000 cP at a temperature of 25° C. The phenolic resole resin as used herein may have a water content of 2-7% by weight based on the total weight of the phenolic resole resin and water, or a water content of 3-6% by weight based on the total weight of the phenolic resole resin and water. The phenolic resole resin as used herein may have a free phenol content of less than 25% by weight relative to the total weight of the phenolic resole resin and water, or less than 20% by weight, or less than 18% by weight. The free phenol content may be between 10% and 20% by weight, or may between 14% and 18% by weight. The phenolic resole resin as used herein may have a free formaldehyde content of less than 3% by weight, or a free formaldehyde content of less than 1% by weight relative to the total weight of the phenolic resole resin and water. The phenolic resole resin may have a pH of 7 or less, or a pH of 6.6 or less. The phenolic resole resin may have any one or any combination of the above disclosed features.

The above disclosed characteristics of the phenolic resole resin may be measured by techniques well known in the art of phenol-formaldehyde resins. For example, the viscosity may be measured with a Brookfield viscometer. The water content may be determined by Karl-Fischer titration. The free phenol content and the free formaldehyde content may be measured by chromatography, such as gas chromatography or liquid chromatography.

The skilled person would also be well acquainted with alternative methods available to measure the above disclosed characteristics of the phenolic resole resin.

### Thermoplastic Microspheres

The thermoplastic microspheres as used herein may have an average particle size from between 1 and 100 microns, or an average particle size from between 2 and 80 microns, or an average particle size from between 5 and 60 microns. The thermoplastic microspheres may be unexpanded, partially expanded or fully expanded or a mixture thereof, and comprise a thermoplastic polymer shell made of a homopolymer or copolymer. Mixtures of different thermoplastic microspheres may be utilised. Preferably, fully expanded thermoplastic microspheres are utilised.

The thermoplastic polymer shell of the thermoplastic microspheres may be derived from monomers selected from the group consisting of acrylonitrile, methacrylonitrile, α-chloroacrylonitrile, α-ethoxyacrylonitrile, fumaroacrylonitrile, crotoacrylonitrile, acrylic esters, methacrylic esters, vinyl chloride, vinylidene chloride, vinylidene dichloride, vinyl pyridine, vinyl esters, and derivatives or mixtures thereof.

The thermoplastic polymer shell may be derived from vinylidene chloride monomer.

Unexpanded or partially expanded thermoplastic microspheres contain a propellant encapsulated within the thermoplastic polymer shell. The microspheres may expand by heating above the boiling point of the propellant and above the softening point of the polymer shell.

The propellant may be a volatile liquid trapped within the polymer shell. Suitable propellants include various short chain alkanes and short chain isoalkanes such as, but not limited to, isopentane, isobutane, n-butane, hexane, heptane, isooctane, petroleum ether and pentane or mixtures thereof.

Suitable thermoplastic microspheres may begin to soften in the temperature range 70-100° C., or 85-95° C. If unexpanded or partially expanded microspheres are used maximum expansion may occur in the temperature range of 100-150° C., or 115-125° C.

The thermoplastic microspheres may be provided in the form of an aqueous dispersion. The amount of thermoplastic microspheres in the aqueous dispersion may be between 2 and 60% by weight based on the total weight of the aqueous dispersion, or between 5 and 40% by weight based on the total weight of the dispersion, or between 10 and 25% by weight based on the total weight of the dispersion.

### Acidic Catalyst

The acidic catalyst as used herein may be a strong inorganic or organic acid or their esters. Strong organic acids include sulphonic acids and their esters including benzene sulphonic acid, toluene sulphonic acid, phenol sulphonic acid, xylene sulphonic acid, β-naphthalene sulphonic acid, α-naphthalene sulphonic acid, esters thereof and mixtures thereof. The acids may further include weak inorganic acids and their esters, either alone or in admixture. The acids that may be employed still further include mixtures of two or more of strong organic acids; mixtures of two or more of esters of strong organic acids; mixtures of two or more of weak inorganic acids; or mixtures of two or more of esters of weak inorganic acids, as well as mixtures of different acids or their esters. Suitable catalysts are phosphate esters and blends of phosphoric acid with strong organic acids such as para-toluene sulphonic acid or any other sulphonic acid or its ester. Mixtures of any two or more of the acids and/or esters may also be used.

Optionally one or more additives such as fillers, surfactants or carbon, optionally in dispersed form, may be added at any one or more of steps a), b) or c) of the herein disclosed processes.

### Fillers

The processes disclosed herein may comprise the optional step of combining a filler with one or more of the thermoplastic microspheres, phenolic resole resin or polystyrene particles or mixtures thereof prior to compression. The filler may be added to the thermoplastic microspheres. A range of fillers is available. One or more fillers may be used depending on the characteristics required of the end product. Suitable, non-limiting fillers include particulate silica, talc, kaolin, clay and titanium dioxide, glass fibre, nanocomposites or nanoparticles. Inorganic compounds, for example particulate inorganic compounds, may be utilised. The filler may be present in amounts of 0.5-60% by weight, or 1-20% by weight, or 2-15% by weight based on the total weight of the composite. The properties of the filler may be suitably modified by treatment with one or more agents, for example to modify the surface properties of the filler. Such treatment may, for example, reduce the solubility of soluble fillers in a liquid, particularly an aqueous liquid. The selection of the modifying agent(s) will depend on the desired characteristics of the filler. One class of modifying agents includes silanes.

The filler may have a particle size between 0.1 mm and 5 mm or the particle size may be between 0.5 mm and 2 mm. The particulate filler may be granular boric acid. The particle size of the granular boric acid may be about 1 mm. The granular boric acid may be treated with a silane to yield a silane coated granular boric acid. The silane may serve to reduce the water solubility of the boric acid.

The thermoplastic microspheres may be combined with the polystyrene particles and the phenolic resole resin, optionally in the presence of filler, and the resulting mixture treated with acidic catalyst.

At least one of the constituents of the composites may be provided in the form of an aqueous solution, dispersion or suspension.

### Other Components

Other components may be included in the processes or composites disclosed herein to improve particular physical properties of the product or to reduce costs. These may be added to one or more of the polystyrene particles, the phenolic resole resin or the thermoplastic microspheres or at any stage of mixing these components. For example, fire retardants containing, for example, chlorine, bromine, boron, phosphorous or ammonia may be added to improve fire resistance. Expandable graphite may also be usefully employed. The graphite may expand when exposed to high temperatures as would be encountered in a fire.

One or more surfactants may also be optionally included in processes or composites disclosed herein. Suitable surfactants include silicone polyethers, for example silicone glycol copolymers.

The surfactants may be added to the mixture of phenolic resin and thermoplastic microspheres, optionally in the presence of fillers and other additives, modifying the surface properties of the mixture and allowing for creation, through, for example, mechanical mixing or aeration, of a resin foam reducing the matrix specific gravity, for example from 0.88 down to 0.45, thus increasing the volume of liquid. The volume of liquid may be doubled or more than doubled. This provides further advantages to the process because the amount of resin used by volume is small and, preferably, it should evenly coat the polystyrene particles, often within short time frames. The mechanically induced foam also persists into the final product and reduces porosity and improves fire performance by slowing the rate of mass loss.

There is also provided a process for preparing a polystyrene-phenolic foam composite comprising the steps of:
a) forming a mixture of thermoplastic microspheres, phenolic resole resin and a surfactant;
b) agitating the mixture formed in a) to increase its volume;
c) combining the mixture formed in b) with an acidic catalyst and polystyrene particles to form a mixture; and
d) curing the mixture formed in c) at a temperature greater than 40° C.;
   wherein the polystyrene particles have a density of less than 15 kg/m³ and;
   wherein the polystyrene-phenolic foam composite has a density of less than 40 kg/m³.

The increase in volume of the mixture in step b) may be greater than 10%, or greater than 20% or greater than 30% or greater than 40% or greater than 50% or greater than 60% or greater than 70% or greater than 80% or greater than 90% or greater than 100% by volume.

Water repellents (hydrophobes) such as silicon containing aqueous emulsions may also be optionally added to control or reduce water absorption. These may reduce water vapour transmission in the final composites.

One or more of the constituents of the processes disclosed herein may be treated with other additives and/or modifiers. For example they may be treated with a thermal conductivity modifier such as carbon, particularly an aqueous dispersed carbon. The dispersed carbon may be present in an amount between 0.5 and 5 wt. % based on the dry weight of the composite components. The thermoplastic microspheres may be treated with a thermal conductivity modifier such as carbon, particularly an aqueous dispersed carbon.

For example, carbon addition may modify the thermal behaviour of the matrix resulting in a slight reduction of thermal conductivity. Additionally the overall native carbon content of the matrix is increased thereby improving fire resistance of the matrix and strengthening the resultant char under fire conditions. A by-product of carbon addition is colouration of the matrix, to a commercially acceptable grey colour. Water based filler dispersions have an advantageous effect on the mixture properties and helps to prevent segregation of the mixture prior to use.

The polystyrene-phenolic foam composites produced from the processes disclosed herein may be characterised by having expanded polystyrene and/or thermoplastic microspheres, at least in part, solubilised in a cured phenolic resin.

The composites may be formed in a hydraulic mould. The composites may be formed in a sheet moulding machine so as to produce one or more sheets. The composites may be formed in a continuous panel press to produce, for example, panels or sheets in a continuous fashion.

One or more steps of the processes disclosed herein may be performed in batch or continuous modes.

The processes disclosed herein may utilise polystyrene particles, thermoplastic microspheres, phenolic resole resin, fillers, treated fillers, and other components as herein disclosed.

The processes may utilise from 10 to 60 wt. % of polystyrene particles, from 20 to 70 wt. % of reactive phenolic resole resin, from 0.5 to 10 wt. % of thermoplastic microspheres, emulsion and from 0.5 to 5 wt. % acidic catalyst based on the total weight of these dry components. The composites may optionally contain from 2 to 15 wt. % filler and from 0.5 to 5 wt. % carbon.

### Composite Formation

On compression at elevated temperature the phenolic resole resin cures and may bind and/or solubilise the polystyrene particles and/or the thermoplastic microspheres, as well as any other beneficial functional additives present.

A pre-heated mould at, for example, 50-60° C. with a mould height, for example, approximately double the required final block height, may be utilised. A cold mould may act as a heat sink and have a deleterious effect on the final cure.

When the mould is filled it may then be moved to a press. The lid may be lowered onto the mould and hydraulically compacted at a slow rate until it reaches the required position. The lid is then locked in place. It may be advantageous to momentarily over-press and then release the mix to the required dimension and thereby achieve more even compaction through the block depth.

Once the mould is filled and compressed, the next stage in the process is to cure the mixture until the phenolic resin has thermoset. This may be achieved by either direct fluid heating of the mould or through placing the mould in an oven at 70-80° C. for about 30 minutes or until the temperature of the block core has peaked at 80-90° C. as determined using a thermocouple inserted into the block.

After curing the block is removed from the mould and may be transferred to a post-cure oven at 70-80° C. for a period of about 2-3 days or until it reaches constant weight. During this process moisture and residual formaldehyde are removed from the block. Insufficient drying will result in stress in the block causing bowing of the sheets as they come off the block cutter.

Compression may be performed at elevated temperatures. The temperature may be greater than 30° C., or greater than 40° C., or greater than 50° C., or greater than 60° C., or greater than 70° C., or greater than 80° C.

Suitable thermoplastic microspheres may begin to soften in the temperature range of 70-100° C., or 85-95° C. However, in the presence of phenolic resole resin, the shells may be plasticised and partially solubilised in the range of 50-70° C., or 55-60° C.

When compressed and heated the polystyrene particles soften and expand due to an increase in the blowing agent vapour pressure. Heat may also soften the phenolic resin. The result of this may be to substantially fuse the polystyrene particles and phenolic foam together into a solid foam. An advantage of the processes disclosed herein is that the resulting composites may be produced quickly and efficiently using standard processing equipment. The compression step may take from 1 minute to 60 minutes, or from 1 minute to 30 minutes, or from 1 minute to 15 minutes.

A feature of curing is the mechanism by which the phenolic resole resin may plasticise and interact physically and/or chemically with the thermoplastic shell of the microspheres and/or with the polystyrene. After processing, the phenolic resin may solubilise, and/or mix and/or cross-link with the thermoplastic homopolymer/copolymer and/or polystyrene and, as a result, a composite product may be formed whereby the phenolic resin modified microspheres and/or polystyrene become highly fire resistant and the phenolic foam so formed is no longer rigid and brittle but is, conversely, tough and resilient in nature.

The expanded polystyrene may be present in the composite in an amount up to 60% by weight, based on the total weight of the composite.

The phenolic resole resin may be present in the composite in an amount up to 50% by weight or more or up to 40% by weight or more, based on the total weight of the composite.

The carbon emulsion may be present in the composite in an amount of 1% by weight or more, or 2% by weight or more, based on the total weight of the composite.

The polystyrene-phenolic foam composite may comprise:
a) up to 60% by weight expanded polystyrene;
b) 35% or more by weight cured phenolic phenol resin; and
c) up to 15% by weight expanded thermoplastic microspheres.
   The foam composite may optionally comprise 1% or more by weight of a carbon emulsion. The foam composite may optionally comprise 3% or more by weight, or 5% or more by weight of a filler, particularly a boric acid filler.

### Properties of the Foam Composites

A feature of the composites is the plasticisation and physical and/or chemical interaction of the cured phenolic resole resin with the thermoplastic shell of the microspheres and/or with the polystyrene particles. The phenolic resin may solubilise, and/or mix, and/or cross-link with the thermoplastic homopolymer/copolymer of the microspheres and/or polystyrene particles and, as a result, a composite product is formed. When the composite is exposed to a heat source it advantageously maintains its structural integrity.

Where physical interaction occurs this may be in the form of polymer entanglement which may form an interpenetrating polymer network.

The foam composites disclosed herein may be semi-resilient and non-friable compared to other structural foams. Densities may be produced in the range 5-40 kg/m³, or 5-35 kg/m³, or 5-30 kg/m³ depending on formulation and additives. The foam composites may have a density less than 40 kg/m³ or less than 38 kg/m³, or less than 36 kg/m³, or less than 34 kg/m³, or less than 32 kg/m³, or less than 30 kg/m³, or less than 28 kg/m³, or less than 26 kg/m³, or less than 24 kg/m³, or less than 22 kg/m³, or less than 20 kg/m³.

The ability to produce such low density composites is highly advantageous. Low density composites are light and are of relatively low cost to transport.

Further, the use of very low density polystyrene (less than 15 kg/m³) allows the proportion of flammable polystyrene to be decreased relative to the proportion of non-flammable phenolic resin.

Despite the very low densities, the composites have good mechanical properties and high strength. It might have been expected that low density composites would suffer a loss of strength however, surprisingly, this was not found to be the case.

Despite the apparently flammable thermoplastic microsphere and polystyrene content, the foam composites are highly resistant to temperature and fire, likely due to the solubilisation of the polymer shell of the microspheres and/or the polystyrene by the phenolic resin. Desirable flame stability is also observed whereas conventional phenolic foams and resin are often subject to spalling/punking. The foam composites possess excellent physical and chemical properties. The cured phenolic resole resin is not rigid and brittle but is, conversely, tough and resilient in nature.

The foam composites disclosed herein may have a specific mass loss rate @ 50 kW/m², measured according to ISO 17554, of less than 8 g/m²·s, or less than 6 g/m²·s, or less than 4 g/m²·s, or less than 2 g/m²·s.

The foam composites disclosed herein may exhibit insulation failure times, according to AS1530.4, for a 100 mm thick panel, of greater than 30 minutes, or greater than 20 minutes, or greater than 10 minutes. The foam composites disclosed herein advantageously may possess low interstitial volume. The interstitial volume may be 5% or less, or 3% or less, or 1% or less, or 0.5% or less, or 0.3% or less.

The foam composites disclosed processes advantageously may possess low water absorption in accordance with ASTM C272 (Standard Test Method for Water Absorption of Core Materials for Sandwich Constructions). The water absorption of the foam composites may be 8% by volume or less, or 7% by volume or less, or 5% by volume or less, or between 4 and 8% by volume, or between 5 and 7% by volume or between 3 and 6% by volume.

There is also provided a foam composite prepared according to any one or the processes as herein disclosed.

There is also provided a composite block comprising the foam composite as herein disclosed.

There is also provided a panel or a sheet comprising the foam composite as herein disclosed.

The blocks, panels and/or sheets find advantageous use in applications requiring thermal and/or acoustic insulation, for example, in construction.

There is also provided a construction material comprising the blocks, panels and/or sheets as hereinbefore disclosed.

### Recycle Step

In any of the above disclosed processes a fraction of the so formed composite material may be ground and utilised in the process for forming further foam composite. Thus, there is also provided a process for preparing a polystyrene-phenolic foam composite comprising the steps of:
a) forming a mixture of thermoplastic microspheres, phenolic resole resin, polystyrene particles, and at least one acidic catalyst; and
b) curing the mixture formed in a) at a temperature greater than 40° C.;
   wherein the polystyrene particles have a density of less than 15 kg/m³ and;
   wherein the polystyrene-phenolic foam composite has a density of less than 40 kg/m³ wherein the mixture formed in a) further comprises cured polystyrene-phenolic foam composite as herein disclosed.

This is advantageous from cost and environmental standpoints. The polystyrene-phenolic foam composites may typically be formed into blocks or panels. This results in off cut material which would usually be disposed of as waste. It has surprisingly been found that if the off cut material is ground into a particulate form it may be utilised as a co-component in the preparation of the polystyrene-phenolic foam composite as herein disclosed.

Up to 20% by weight of off-cut material may be utilised, or up to 10% by weight, based on the total weight of the mixture.

Other suitable particulate material of a cellular foam form may also be utilised in the any of the hereinbefore processes. Alternatively, any low density particulate material having a density less than 100 kg/m3 may be utilised. For example, cork.

The size of the particulate material may be about 10 mm or less. Preferably the size of the particulate material substantially matches that of the polystyrene particles. A preferred size range is 3 mm to 6 mm. The particle size matching may prevent an increase in surface area of the aggregate overall. If the particle size is too small the increase in surface area of the aggregate may absorb too much of the matrix comprising thermoplastic microspheres and phenolic resole resin. In the grinding of the polystyrene-phenolic foam composite a significant amount of dust may be generated and this may be combined with the matrix of thermoplastic microspheres and phenolic resole resin so that optimum recovery is achieved.

Throughout this specification, use of the terms “comprises” or “comprising” or grammatical variations thereon shall be taken to specify the presence of stated features, integers, steps or components but does not preclude the presence or addition of one or more other features, integers, steps, components or groups thereof not specifically mentioned.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited.

### BRIEF DESCRIPTION OF THE DRAWING

The FIGURE illustrates a flow diagram of a process according to an embodiment of the present disclosure.

### DETAILED DESCRIPTION

It will now be convenient to describe the disclosure with reference to particular embodiments and examples. These embodiments and examples are illustrative only and should not be construed as limiting upon the scope of the disclosure. It will be understood that variations upon the described disclosure as would be apparent to the skilled addressee are within the scope of the disclosure. Similarly, the present disclosure is capable of finding application in areas that are not explicitly recited in this document and the fact that some applications are not specifically described should not be considered as a limitation on the overall applicability of the disclosure.

### Thermoplastic Microspheres

When thermoplastic microspheres are heated, the polymeric shell gradually softens, and the liquid within the shell begins to gasify and expand. When the heat is removed, the shell stiffens and the microsphere remains in its expanded form. When fully expanded, the volume of the microspheres may increase more than 40 times. Significant density reductions can be achieved with even a small concentration of, for example, 3% thermoplastic microspheres by weight. A benefit of the hollow microsphere is the potential to reduce part weight, which is a function of density. Compared to traditional mineral-based additives, such as calcium carbonate, gypsum, mica, silica and talc, hollow microspheres have much lower densities. Loadings may be 1-5% by weight, which can equate to 25% or more by volume.

Thermoplastic microspheres suitable for preparing the foam composites as disclosed herein may be utilised in various forms. They may be in the form of a slurry dispersed in water or they may be utilised in dry form. Aqueous dispersions are preferred. Suitable microspheres are supplied by AkzoNobel under the trade mark Expancel®.

### Phenolic Resole Resin

A suitable phenolic resole resin may be produced by the base-catalysed condensation reaction of a molar excess of an aldehyde, with a substituted or unsubstituted phenol. Preferred substituted phenols are those in which the substituent does not impede the condensation of the phenol(s) with the aldehyde(s). Suitable substituents include halogens or a hydroxy, alkyl or an aryl group. Unsubstituted phenol is most preferred. Suitable aldehydes are formaldehyde (including oligomers/polymers such as trioxane), furfural, sugars and cellulose hydrolysates. A preferred aldehyde is formaldehyde. In one embodiment the molar ratio of aldehyde to phenol is from 1.4 to 1.8:1, for example, about 1.6:1. The temperature at which the phenolic resole resin is prepared may be less than 65° C., for example no more than 60° C.±2° C., or no more than about 60° C. This temperature of less than 65° C. is preferably maintained while the basic catalyst is active, that is, until the basic catalyst is neutralised. This temperature may allow the maximum substitution of the phenol aromatic ring by reactive methylol (—CH₂OH) groups and results in only low molecular weight development in the polymer. Water may then be optionally distilled off to the preferred specification. Due to the resulting low molecular weight (preferably less than 1000 Daltons), the phenolic resole resin is highly soluble in water without phase separation and remains sufficiently reactive to cross-link under dilute aqueous conditions.

Suitable alkaline condensation catalysts are ammonia, ammonium hydroxide, sodium hydroxide, potassium hydroxide and barium hydroxide. Sodium hydroxide is a preferred catalyst.

The phenolic resole resin may be produced from phenol with a molar excess of formaldehyde in the presence of sodium hydroxide as a condensation catalyst.

Conventional phenolic resins may be produced by carefully increasing the temperature to around 60±2° C. and holding there for a period of about 1 hour, after which the temperature is increased to around 80° C. for a further period of 2-4 hours. The two stages essentially are:

1. Ring Substitution at 60° C. by formaldehyde into the phenol aromatic ring; and

2. Condensation Polymerisation at 80° C. to increase molecular weight.

In contrast, the phenolic resole resin as used herein may be obtained, for example, by only heating to no more than 65° C., for example, no more than 60±2° C. or no more than about 60° C. for a period of about 5 hours or until an intermediate viscosity of 13.5-14.5 centiStokes at 25° C. is reached for the reaction mixture. This leads to maximum substitution by methylol (—CH₂OH) groups in ortho-, meta- and para-positions of the aromatic ring and only low molecular weight build. The mixture may then be neutralised with an acid such as para-toluene sulphonic acid to a pH of less than 7, or between 5.5-6.6, or about 6 and most of the process and reaction water may then be distilled off under vacuum down to a level of around 2-7%, resulting in a highly reactive material.

### Fillers

The composites may comprise one or more fillers. Suitable, non limiting fillers include inorganic compounds, particularly particulate inorganic compounds.

Exemplary fillers include elemental metal selected from the group consisting of metals of Groups I, II, III and IV, transition metals or the like of the periodic table, oxides or complex oxides of these metals, salts of these metals, such as fluorides, carbonates, sulfates, silicates, hydroxides, chlorides, sulfites, and phosphates of these metals, and composites of these salts of metals. Preferably used are metal oxides such as amorphous silica, quartz, alumina, titania, zirconia, barium oxide, yttrium oxide, lanthanum oxide, and ytterbium oxide, silica-based complex oxides such as silica-zirconia, silica-titania, silica-titania-barium oxide, and silica-titania-zirconia, glass such as borosilicate glass, glass fibres, aluminosilicate glass, or fluoroaluminosilicate glass, metal fluorides such as barium fluoride, strontium fluoride, yttrium fluoride, lanthanum fluoride, and ytterbium fluoride; inorganic carbonates such as calcium carbonate, magnesium carbonate, strontium carbonate, and barium carbonate; and metal sulfates such as magnesium sulfate and barium sulfate. Other suitable fillers include particulate silica, talc, kaolin, clay, nanocomposites and nanoparticles. Other inorganic compounds such as boric acid may be utilised as a filler.

The filler may be present in amounts of 0.5-60% by weight, or 1-20% by weight or 2-15% by weight, based on the total weight of the composite.

The filler may have a particle size between 0.1 mm and 5 mm, or between 0.5 mm and 2 mm. One preferred particulate filler is granular boric acid. Granular boric acids of particle size of about 1 mm may be suitable.

The filler may contribute to fire inhibition. For example, at 170° C. boric acid dehydrates to metaboric acid releasing a water molecule and thus quenching combustion by exclusion of oxygen. Above 300° C. a further dehydration occurs releasing another water molecule and forming the non-combustible compound boron trioxide.

### Modified Fillers

Often it is advantageous to treat fillers with a modifiying agent so as to modify the surface properties of the filler. For example fillers may be modified with agents so as to change the fillers solubility properties. Suitable modifiying agents are well known in the art. One class of modifying agents are silanes. One class of silanes are haloalkylsilanes examples of which are 3-chloropropyltrimethoxysilane, 3-chloropropyltriethoxysilane, 3-chloropropyltripropoxysilane, chloropropylmethyldimethoxysilane, chloropropylmethyldiethoxysilane, chloropropyldimethylethoxysilane, chloropropyldimethylmethoxysilane, chloroethyltrimethoxysilane, chloroethyltriethoxy-silane, chloroethylmethyldimethoxysilane, chloroethylmethyldiethoxysilane, chloroethyldimethylmethoxysilane, chloroethyldimethylethoxysilane, chloromethyltriethoxy-silane, chloromethyltrimethoxysilane, chloromethylmethyl-dimethoxysilane, chloromethylmethyldiethoxysilane, chloro-methyldimethylmethoxysilane or chloromethyldimethylethoxysilane.

Granular boric acid may be treated with one or more of the above silanes so as to reduce the solubility of the boric acid in water.

In one embodiment expanded thermoplastic microspheres, filler (for example surface treated boric acid) and aqueous carbon dispersion are combined. In a separate vessel phenolic resin is treated with surfactant and the mixture aerated to increase the volume. The volume of the mixture may double. The mixture is then added to the mixture containing the thermoplastic microspheres. Acidic catalyst is then added and the resulting mixture added to expanded polystyrene. The resulting coated polystyrene is then moulded, compressed and cured.

### Materials and Process

Expanded polystyrene of density less than 15 kg/m³ was prepared by steam expansion of commercially available expandable polystyrene. Expanded polymeric microspheres were Expancel 461WE 40 available from Akzo Nobel. Granular boric acid was technical grade and was treated with chloropropyltrimethoxysilane before use. Aqueous carbon black dispersion was Gold Cup Black-CB RF from Racing Colours Ltd. Surfactant was a polyether modified hydroxyl-functional polysiloxane. Hydrophobe was aqueous silicone emulsion from Dow Corning.

Referring to the FIGURE there is illustrated a flow diagram of the process according to an embodiment of the present disclosure.

A volume of expanded polystyrene and equivalent to approximately 1.6 times (160%) of the final desired block volume was transferred to a blender.

Phenolic resole resin (as hereinbefore described) a mixture of expanded thermoplastic microspheres, granular boric acid and carbon black dispersion and a surfactant were blended in an aerating slurry mixer to an even consistency.

A hydrophobic agent and acidic catalyst were then added and the resulting mixture added to the expanded polystyrene.

After mixing, the blend was fed into a pre-heated mould at, for example, 45-55° C. The blend was then compressed to the required level using a hydraulic press.

The filled mould was then heated to cure the mixture.

Once cured, the mould was demoulded. The block was then placed in a post-cure oven, for example at 70-80° C., for 48+ hrs to allow remaining moisture to evaporate, residual formaldehyde to be captured and, if required, to complete the cure.

Finally, the block was cut into sheets of the specified thickness using an abrasive wire cutter or horizontal band saw.

The following examples describe composites made according to the above process.

### Example 1

A composite was prepared utilising the following raw materials (based on the dry weight of the materials). The composite had a density of 34.5 kg/m³.

| Raw material | Composition (wt. %) |
|---|---|
| EPS (10.5 kg/m³) | 38.4 |
| Phenolic resin | 44.4 |
| Surfactant | 0.89 |
| Microspheres | 4.44 |
| Boric acid | 6.67 |
| Carbon emulsion | 2.22 |
| Hydrophobe | 0.44 |
| Acid catalyst | 2.44 |

### Example 2

A composite was prepared utilising the following raw materials (based on the dry weight of the materials). The composite had a density of 25.5 kg/m³.

| Raw material | Composition (wt. %) |
|---|---|
| EPS (5 kg/m³) | 27.8 |
| Phenolic resin | 52.1 |
| Surfactant | 1.04 |
| Microspheres | 5.21 |
| Boric acid | 7.82 |
| Carbon emulsion | 2.61 |
| Hydrophobe | 0.52 |
| Acid catalyst | 2.87 |

### Example 3

A composite was prepared utilising the following raw materials (based on the dry weight of the materials). The composite had a density of 34.1 kg/m³.

| Raw material | Composition (wt. %) |
|---|---|
| EPS (11 kg/m³) | 37.9 |
| Phenolic resin | 44.8 |
| Surfactant | 0.90 |
| Microspheres | 4.48 |
| Boric acid | 6.72 |
| Carbon emulsion | 2.24 |
| Hydrophobe | 0.45 |
| Acid catalyst | 2.46 |

It was found that all of the composites had excellent physical properties (low interstitial volume and low water absorption) demonstrating advantage over a wide range of relative component amounts. The mechanical properties of the composites were equivalent to expanded polystyrene.

### Fire Resistance Testing

Test specimens consisted of insulated wall panels comprising foam composites as prepared by the processes disclosed herein. The panels were 3.0 m high, 1.2 m or 0.6 m broad and had a thickness of 50 mm, 100 mm and 250 mm. A comparative test was performed with a 125 mm thick expanded polystyrene panel. Tests were conducted in accordance with AS 1530.4 ‘Methods for fire tests on building materials, components and structures, Part 4: Fire resistance tests of elements of construction, Section 3 Walls—Vertical Separating Elements’. The results are collected in the below Table.

| | Insulation failure time |
|---|---|
| Material and thickness | (minutes) |
| Inventive composite 50 mm | 15 |
| Inventive composite 100 mm | 31 |
| Inventive composite 250 mm | 115 |
| Comparative Polystyrene 125 mm | 6 |

It is clear from the results that the composites prepared by the processes disclosed herein significantly outperform expanded polystyrene in fire resistance.

Tests were conducted following ISO 17554. This is a small-scale method for assessing the mass loss rate of essentially flat specimens exposed in the horizontal orientation to controlled levels of radiant heating with an external igniter under well-ventilated conditions. The mass loss rate is determined by measurement of the specimen mass and is derived numerically. Mass loss rate can be used as an indirect measure of heat release rate.

Under the conditions of the test expanded polystyrene had an average specific mass loss rate @ 50 kW/m², over three tests, of 9.88 g/m²·s, whereas composites prepared by the processes disclosed herein had an average specific mass loss rate @ 50 kW/m², over three tests, of 1.26 g/m²·s. Accordingly, significantly slower combustion was observed with the inventive composites.

A composite was also prepared absent both boric acid and carbon emulsion as in the following Table. Small amounts of surfactant and hydrophobe were also added, although these are optional.

| Raw material | Composition (wt. %) |
|---|---|
| EPS | 42.3 |
| Phenolic resin | 49.9 |
| Microspheres | 5.0 |
| Acid catalyst | 2.9 |

This composite had an average specific mass loss rate @ 50 kW/m² of 1.63 g/m²·s. Therefore, the presence of boric acid and carbon fillers, while slightly improving the mass loss rate, are both not necessary components in providing a composite with significantly enhanced fire resisting properties, compared to EPS.

1. A process for preparing a polystyrene-phenolic foam composite comprising the steps of:
a) forming a mixture of thermoplastic microspheres, phenolic resole resin, polystyrene particles and at least one acidic catalyst; and
b) curing the mixture formed in a) at a temperature above 40° C.;
wherein the polystyrene particles have a density of less than 15 kg/m³ and;
wherein the polystyrene-phenolic foam composite has a density of less than 40 kg/m³.

2. A process according to claim 1, comprising the steps of:
a) forming a mixture of thermoplastic microspheres, phenolic resole resin and at least one acidic catalyst;
b) combining the mixture formed in a) with polystyrene particles to form a mixture; and
c) curing the mixture formed in b) at a temperature above 40° C.;
wherein the polystyrene particles have a density of less than 15 kg/m³ and;
wherein the polystyrene-phenolic foam composite has a density of less than 40 kg/m³.

3. A process according to claim 1, comprising the steps of:
a) forming a mixture of expanded thermoplastic microspheres and phenolic resole resin;
b) combining the mixture formed in a) with at least one acidic catalyst;
c) combining the mixture formed in b) with polystyrene particles; and
d) curing the mixture formed in c) at a temperature above 40° C.;
wherein the polystyrene particles have a density of less than 15 kg/m³ and;
wherein the polystyrene-phenolic foam composite has a density of less than 40 kg/m³.

4. A process according to claim 1, wherein the polystyrene particles are partially or fully expanded.

5. A process according to claim 1, wherein the density of the polystyrene particles is less than 12 kg/m³.

6. A process according to claim 1, further comprising the step of adding one or more fillers.

7. A process according to claim 6, wherein the filler is added in an amount of 0.5-60% by weight based on the total weight of the composition.

8. A process according to claim 7, wherein the filler is a surface treated filler.

9. A process according to claim 6, wherein the filler is added to the thermoplastic microspheres.

10. A process according to claim 1, further comprising the step of adding an aqueous carbon dispersion.

11. A process according to claim 6, wherein the filler is added to a mixture of thermoplastic microspheres and aqueous carbon dispersion.

12. A process according to claim 1, wherein the phenolic resole resin has one or more of the following properties:
(a) a viscosity between 500 and 4,000 cP;
(b) a water content between 2 and 7% by weight;
(c) a free phenol content less than 25%; or
(d) a free formaldehyde content of less than 3%.

13. A process according to claim 1, further comprising the step of adding a surfactant.

14. A process according to claim 13, wherein the surfactant is added to a mixture comprising the phenolic resin.

15. A process according to claim 14, wherein the agitation of the phenolic resin-surfactant mixture increases the volume of said mixture.

16. A process according to claim 1, wherein the thermoplastic microspheres have an average particle size from between 1 and 80 microns.

17. A process according to claim 16, wherein the thermoplastic microspheres have a thermoplastic polymer shell derived from monomers selected from the group consisting of acrylonitrile, methacrylonitrile, α-chloroacrylonitrile, α-ethoxyacrylonitrile, fumaroacrylonitrile, crotoacrylonitrile, acrylic esters, methacrylic esters, vinyl chloride, vinylidene chloride, vinylidene dichloride, vinyl pyridine, vinyl esters, and derivatives or mixtures thereof.

18. A process according to claim 1, wherein the acidic catalyst is selected from a strong organic acid, an ester of a strong organic acid, a weak inorganic acid, an ester of a weak inorganic acid or mixtures thereof.

19. A process according to claim 1, wherein steam is not added to the curing step.

20. A process according to claim 1, wherein cured polystyrene-phenolic foam composite is added to the mixture prior to curing.

21. A process according to claim 20, wherein the cured polystyrene-phenolic foam composite is in particulate form.

22. A foam composite produced by the process according to claim 1.

23. A foam composite according to claim 22, wherein the specific mass loss rate @ 50 kW/m², measured according to ISO 17554, is less than 8 g/m²·s.

24. A foam composite according to claim 22, wherein the composite exhibits an insulation failure time, according to AS1530.4, for a 100 mm thick panel, of greater than 10 minutes.

25. A composite block, panel or sheet for use in construction comprising the foam composite according to claim 22.

26. A polystyrene-phenolic foam composite comprising:
a) expanded polystyrene having a density of less than 15 kg/m³;
b) cured phenolic resole resin; and
c) expanded thermoplastic microspheres;
wherein the composite has a density of less than 40 kg/m³.
